(19) United States
(12) Patent Application Publication
(10) Pub. No.: US 2016/0293291 A1
(43) Pub. Date: Oct. 6, 2016

(54) ELECTRIC WIRE FOR VEHICLE AND WIRE HARNESS USING ELECTRIC WIRE

(71) Applicant: YAZAKI CORPORATION, Tokyo (JP)

(72) Inventor: Kosuke KOGO, Susono-shi (JP)

(73) Assignee: YAZAKI CORPORATION, Tokyo (JP)

(21) Appl. No.: 15/090,740

(22) Filed: Apr. 5, 2016

(30) Foreign Application Priority Data
Apr. 6, 2015 (JP) 2015-077381

(51) Int. Cl. H01B 3/44; H01B 7/29; B60R 16/02

(52) U.S. Cl. CPC H01B 3/443; B60R 16/0207; H01B 7/292

(57) ABSTRACT

Provided is an electric wire (1) for a vehicle having improved heat resistance and a wire harness using the electric wire (1), the electric wire (1) including an insulating coating (3) including a vinyl chloride resin, a plasticizer and filler containing an inorganic compound, and a conductor (2) covered with the insulating coating (3), wherein the number of abrasion cycles is five or greater when a scrape abrasion test is performed in accordance with ISO 6722:2006 on the electric wire (1) having a total wire diameter in a range of 1.4 mm to 2.8 mm including a thickness of the insulating coating in a range of 0.24 mm to 0.4 mm, in a state where an abrading wire having a diameter of 0.45±0.01 mm is used for abrading and a load of 5±0.05 N is applied to the electric wire under an atmosphere of 100±1° C.

### CROSS REFERENCE TO RELATED APPLICATIONS

This application claims the priority of Japanese Patent Application No. 2015-077381, filed on Apr. 6, 2015, the entire content of which are incorporated herein by reference.

### BACKGROUND

1. Technical Field

The present disclosure relates to an electric wire for a vehicle having improved heat resistance and a wire harness using the electric wire.

2. Related Art

Insulated electric wires used in high temperature conditions, for example, in engine compartments of vehicles are required to have high heat resistance. Coating materials for insulated electric wires used under such conditions typically contain crosslinked polyethylene. The use of crosslinked polyethylene for coating materials can ensure high heat aging resistance and further improve the heat resistance when crosslinking treatment is performed thereon.

Such crosslinked polyethylene, however, exerts a negative influence on the environment in the process of production because the crosslinking treatment is essential for the improvement of the heat resistance. In order to deal with such a problem, vinyl chloride resins, which are inexpensive and easily processed but not required to be subjected to a crosslinking treatment, have been considered for use in coating materials for insulated electric wires.

For example, JP H11-176240 A describes a vinyl chloride resin composition for heat-resistant wire coating containing predetermined amounts of a hydrotalcite compound and a trimellitate plasticizer to a vinyl chloride resin. The use of such a composition can improve a heat resistance with no harmful heavy metal such as lead or barium used together.

The electric wire described in JP H11-176240 A still has a problem with heat resistance, which is not sufficient for use in a vehicle as an insulated electric wire and may lead to poor electrical insulation performance under high temperature conditions.

### SUMMARY

The present invention has been made in order to solve the conventional problems and provides an electric wire for a vehicle having improved heat resistance and a wire harness using the electric wire.

An electric wire for a vehicle according to a first aspect of the present invention includes an insulating coating including a vinyl chloride resin, a plasticizer, and filler containing an inorganic compound having a flat shape, and a conductor covered with the insulating coating. The number of abrasion cycles is five or greater when a scrape abrasion test is performed in accordance with ISO 6722:2006 on the electric wire having a total wire diameter in a range of 1.4 mm to 2.8 mm including a thickness of the insulating coating in a range of 0.24 mm to 0.4 mm, in a state where an abrading wire having a diameter of 0.45±0.01 mm is used for abrading and a load of 5±0.05 N is applied to the electric wire under an atmosphere of 100±1° C.

The insulating coating may contain the plasticizer in a range of 20 to 40 parts by mass per 100 parts by mass of the vinyl chloride resin, and may contain the filler in a range of 1 to 15 parts by mass per 100 parts by mass of the vinyl chloride resin.

A weight-average degree of polymerization of the vinyl chloride resin may be in a range of 2000 to 3000, and the plasticizer may be at least one of a trimellitic acid plasticizer and a pyromellitic acid plasticizer.

A wire harness according to a second aspect of the present invention includes the electric wire for a vehicle according to the first aspect.

The electric wire for a vehicle according to the present invention includes the insulating coating including the filler containing the inorganic compound having a flat shape. The electric wire can therefore ensure high heat resistance for a long period of time and exert good electrical insulation performance even when used under high temperature conditions.

### BRIEF DESCRIPTION OF THE DRAWINGS

FIG. 1 is a cross-sectional view showing an electric wire for a vehicle according to an embodiment of the present invention;

FIG. 2 is a scanning electron micrograph showing flat filler 1 used in the Examples; and

FIG. 3 is a scanning electron micrograph showing flat filler 2 used in the Examples.

### DETAILED DESCRIPTION

An electric wire for a vehicle according to an embodiment of the present invention will be explained in detail below with reference to the drawings. It should be noted that dimensional ratios in the drawings are magnified for convenience of explanation and can be different from actual ratios.

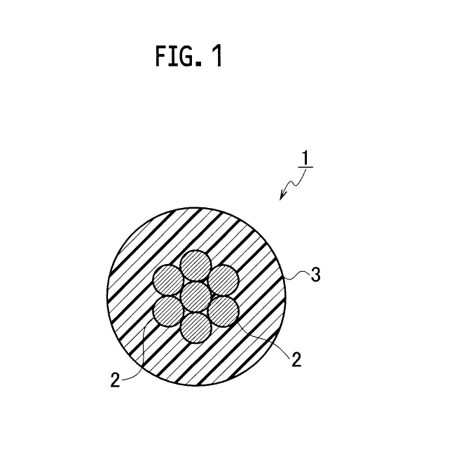

As shown in FIG. 1, the electric wire 1 for a vehicle according to the present embodiment includes a conductor 2 and an insulating coating 3 covering the circumference of the conductor 2.

The conductor 2 may be a solid conductor of a single strand or a stranded conductor including a plurality of strands. The stranded conductor may be any of: a concentric stranded conductor having a center core of a single strand or multiple strands and including strands concentrically stranded around the center core; a bunch stranded conductor including a plurality of strands stranded and bundled together in the same direction; and a rope lay conductor including a plurality of bunch stranded conductors stranded concentrically.

The diameter of the conductor 2 or each strand included in the conductor 2 is not particularly limited. The material of the conductor 2 may be, but is not limited to, a conventionally-known conductive metal material such as copper, a copper alloy, aluminum, or an aluminum alloy. The surface of the conductor 2 may be subjected to plating treatment such as tin plating, silver plating or nickel plating.

The insulating coating 3 covering the circumference of the conductor 2 includes a resin composition capable of insulating the conductor 2. In particular, the insulating coating 3 contains a vinyl chloride resin and a plasticizer. The insulating coating 3 according to the present embodiment further includes filler containing an inorganic compound having a flat shape in order to improve heat resistance. The vinyl chloride resin and the plasticizer mixed with the filler can ensure the heat resistance of the insulating coating 3 for a long period of time and exert good electric insulation performance even when used in high temperature conditions, for example, in an engine compartment of a vehicle.

Examples of the vinyl chloride resin used in the insulating coating 3 include polyvinyl chloride, chlorinated polyvinyl chloride, polyvinylidene chloride, chlorinated polyethylene, a vinyl chloride-vinyl acetate copolymer, a vinyl chloride-ethylene copolymer, a vinyl chloride-propylene copolymer, a vinyl chloride-styrene copolymer, a vinyl chloride-isobutylene copolymer, a vinyl chloride-vinylidene chloride copolymer, a vinyl chloride-styrene-maleic anhydride copolymer, a vinyl chloride-styrene-acrylonitrile copolymer, a vinyl chloride-butadiene copolymer, a vinyl chloride-isoprene copolymer, a vinyl chloride-chlorinated propylene copolymer, a vinyl chloride-vinylidene chloride-vinyl acetate copolymer, a vinyl chloride-maleic acid ester copolymer, a vinyl chloride-methacrylate ester copolymer, a vinyl chloride-acrylonitrile copolymer, and copolymers of vinyl chloride and various kinds of vinyl ether. These vinyl chloride resins may be used singly or in combination. Examples of polymerization of the vinyl chloride resin may include, but are not limited to, bulk polymerization, solution polymerization, suspension polymerization, and emulsion polymerization.

An average polymerization degree (weight-average degree of polymerization) of the vinyl chloride resin is not particularly limited but preferably in the range of 500 to 5000, more preferably in the range of 1500 to 3000. The average polymerization degree set to 500 or greater can suppress a decrease of heat resistance of the insulating coating 3 obtained. In addition, the average polymerization degree set to 5000 or lower can suppress an increase in melt viscosity at the time of extrusion molding and a decrease in kneading and molding processability. The insulating coating 3 according to the present embodiment may contain one or more kinds of vinyl chloride resins together having the polymerization degree in the range described above.

The plasticizer used in the insulating coating 3 is not particularly limited as long as it can penetrate between molecules of the vinyl chloride resin so as to reduce intermolecular interactions between the molecules and provide flexibility to the vinyl chloride resin. The plasticizer in the present embodiment, however, preferably contains one or more plasticizers selected from trimellitic acid plasticizers and pyromellitic acid plasticizers. Trimellitic acid plasticizers and pyromellitic acid plasticizers have high heat resistance, high weather resistance and low volatility, and are therefore suitable for use in the insulating coating 3 which is required to ensure heat resistance for a long period of time.

Examples of such trimellitic acid plasticizers include trimellitic acid esters. Examples of such pyromellitic acid plasticizers include pyromellitic acid esters. Examples of alcohols constituting esters by dehydration synthesis in these trimellitic acid and pyromellitic acid plasticizers include saturated aliphatic alcohols containing from 8 to 13 carbon atoms. These alcohols may be used singly or in combination.

The plasticizer used in the insulating coating 3 may further include other types of plasticizers, other than the trimellitic acid and pyromellitic acid plasticizers. Examples of other plasticizers include phthalic acid plasticizers and aliphatic plasticizers. When the entire amount of the plasticizers contained is within a predetermined range described below, and the amount of each of a trimellitic acid plasticizer and a pyromellitic acid plasticizer is within a predetermined range, the insulating coating 3 can improve the heat resistance while ensuring the flexibility. At least one of the trimellitic acid plasticizer and the pyromellitic acid plasticizer is preferably a main plasticizer included in the insulating coating 3. Namely, the total amount of the trimellitic acid plasticizer and the pyromellitic acid plasticizer is 50% by mass or greater of the entire amount of the plasticizer included in the insulating coating 3 is preferably, more preferably 70% by mass or greater, particularly preferably 95% by mass or greater.

Examples of phthalic acid plasticizers include phthalic acid esters. Examples of alcohols constituting esters by dehydration synthesis in the phthalic acid plasticizers include saturated aliphatic alcohols containing from 8 to 13 carbon atoms. These alcohols may be used singly or in combination. A more specific example of the phthalic acid plasticizers may be at least one compound selected from the group consisting of di-2-ethylhexyl phthalate, di-n-octyl phthalate, diisononyl phthalate, dinonyl phthalate, diisodecyl phthalate, and ditridecyl phthalate.

An example of aliphatic plasticizers may be at least one compound selected from the group consisting of adipate esters, sebacate esters, and azelate esters. Examples of alcohols constituting esters by dehydration synthesis in these compounds include saturated aliphatic alcohols containing from 8 to 13 carbon atoms. These alcohols may be used singly or in combination. A more specific example of the aliphatic plasticizers may be at least one compound selected from the group consisting of dioctyl adipate, isononyl adipate, dibutyl sebacate, dioctyl sebacate, and dioctyl azelate.

The content of the plasticizer is preferably 20 to 40 parts by mass per 100 parts by mass of the vinyl chloride resin. The plasticizer of 20 parts by mass or greater can prevent the flexibility from decreasing to cause poor durability at low temperature. In addition, the plasticizer of 40 parts by mass or less can increase the processability in association with the increase of the flexibility and further provide abrasion resistance at high temperature.

As described above, the insulating coating 3 in the electric wire 1 for a vehicle includes the filler containing the inorganic compound having a flat shape in order to ensure heat resistance and electrical insulation performance under high temperature conditions for a long period of time. The use of the filler having a flat shape can increase resistance to scrape abrasion at high temperature.

The filler used in the present embodiment is characterized by the flat shape of the filler. An aspect ratio of a thickness of the filler to a maximum diameter of a main surface of the filler (a maximum length in the direction vertical to the thickness direction) (the ratio=the maximum diameter of the main surface/the thickness) is preferably in the range of 5 or greater to less than 15. The aspect ratio set to this range can keep the state of the resin composition tolerant to mechanical stress under high temperature conditions due to the flat shape distinctive of the filler added to the resin, so as to increase resistance to scrape abrasion of the insulating coating 3 at high temperature. In addition, the aspect ratio set to this range can minimize the influence of deformation of the resin in the insulating coating 3 due to the filler when the insulating coating 3 is provided on the circumference of the conductor 2. If the aspect ratio is 15 or greater, the resistance to mechanical stress at low temperature (the low-temperature properties) may decrease. The flatness and the aspect ratio of the filer can be confirmed by observations with an electron microscope.

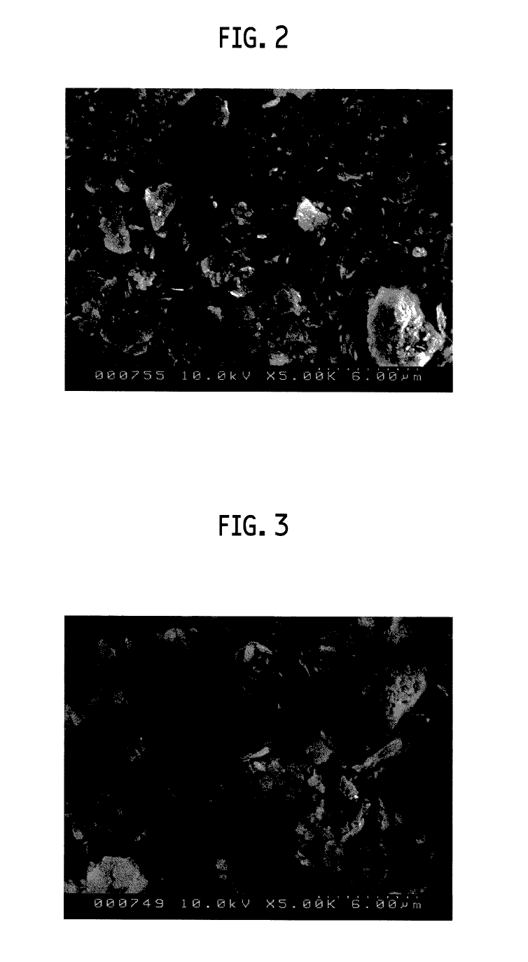

An average diameter of the filler is not particularly limited as long as the filler has a flat shape, as shown in FIG. 2 and FIG. 3, but is preferably in the range of 0.5 μm to 5 μm. The average diameter, the aspect ratio, and the shape of the filler can be measured in such a manner as to observe the insulating coating 3 with a scanning electron microscope (SEM).

The filler is not particularly limited as long as it contains the inorganic compound having a flat shape. The inorganic compound having a flat shape is preferably at least one compound selected from the group consisting of kaolin, pyrophyllite, talc, mica, clay, smectite, aluminum hydroxide (Al(OH)₃), and magnesium hydroxide (Mg(OH)₂). The inorganic compound having a flat shape is particularly preferably mica or clay.

The content of the filler in the insulating coating 3 is preferably in the range of 1 to 15 parts by mass per 100 parts by mass of the vinyl chloride resin. The filler of 1 part by mass or greater can improve the heat resistance and the resistance to scrape abrasion of the insulating coating 3. In addition, the filler of 15 parts by mass or less can prevent the durability from decreasing at low temperature caused by the shape of the filler.

The insulating coating 3 according to the present embodiment may further include various additives in addition to the materials described above. Examples of additives include a stabilizer, a pigment, an antioxidant, an extender, a metal inactivator, an aging inhibitor, a lubricant, a reinforcing agent, an ultraviolet absorber, a dye, a coloring agent, an antistatic agent, and a foaming agent.

Next, a method for manufacturing the electric wire 1 for a vehicle according to the present embodiment is explained below. The insulating coating 3 of the electric wire 1 for a vehicle may be prepared by heating and kneading the materials described above by a conventionally known method. For example, the materials described above are kneaded with a known kneading machine such as a Banbury mixer, a pressure kneader, a kneading extruder, a twin screw extruder or a roll mill so as to obtain a resin composition of the insulating coating 3. Alternatively, the materials may be preliminarily dry-blended in a tumbler and then kneaded with the kneading machine described above. The resin composition after heated and kneaded is taken out of the kncading machine, and may be pelletized by a pelletizer.

In the manufacture of the electric wire 1 for a vehicle, the conductor 2 may be covered with the insulating coating 3 by a conventionally known method. For example, the insulating coating 3 may be formed by a common extrusion molding method. An extruder used for extrusion molding may be a single screw extruder or a twin screw extruder including a screw, breaker plate, crosshead, distributor, nipple, and die.

The method for manufacturing the electric wire 1 for a vehicle is explained in more detail below. First, the vinyl chloride resin is poured into a two screw extruder heated to a temperature sufficient to melt the vinyl chloride resin. At the same time, the plasticizer, the filler and other additives described above as necessary are also put into the two screw extruder. The vinyl chloride resin and the other materials are melted and kneaded by screws, and a predetermined amount of the vinyl chloride resin and the other materials are supplied to a crosshead through a breaker plate. The melted vinyl chloride resin kneaded with the other materials flows onto a periphery of a nipple via a distributor, and is extruded through a die and provided on the circumference of the conductor. Accordingly, the insulating coating 3 covering the circumference of the conductor 2 can be obtained.

The electric wire 1 for a vehicle according to the present embodiment includes the insulating coating 3 including the vinyl chloride resin, the plasticizer and the filler containing the inorganic compound having a flat shape, and the conductor 2 covered with the insulating coating 3. When the electric wire 1 having a total wire diameter in the range of 1.4 mm to 2.8 mm including a thickness of the insulating coating 3 in the range of 0.24 mm to 0.4 mm, is subjected to a scrape abrasion test in accordance with ISO 6722:2006, the number of abrasion cycles is five or greater in a state where an abrading wire having a diameter of 0.45±0.01 mm is used for abrading and a load of 5±0.05 N is applied to the electric wire 1 under an atmosphere of 100±1° C. Since the insulating coating 3 according to the present embodiment includes the filler containing the inorganic compound having a flat shape, the electric wire 1 can ensure high heat resistance for a long period of time and therefore exert good electrical insulation performance even when used under high temperature conditions. In addition, the plasticizer included in the insulating coating 3 can increase the flexibility, so as to improve the durability of the insulating coating 3 at low temperature.

Further, the electric wire 1 for a vehicle according to the present embodiment includes the insulating coating 3 including the resin composition having a high heat resistance and therefore can be arranged adjacent to components with high temperature such as an internal combustion engine, a motor, and a converter. Thus, the electric wire 1 is suitable for use in vehicles such as electric vehicles.

A wire harness according to the present embodiment includes the electric wire 1. Since the electric wire 1 for a vehicle according to the present embodiment has higher heat resistance than conventional electric wires, the electric wire 1 can be used suitably in the wire harness for a vehicle required to have high heat resistance, durability and electric conductivity.

### EXAMPLES

The following Examples and Comparative Examples are intended to illustrate the invention in more detail, and should not be construed as limiting the scope of the invention.

First, the following vinyl chloride resin, plasticizer, filler, stabilizer and processing auxiliary agent were melted and kneaded with amounts shown in Tables 1 to 4 with a kneading machine, so as to prepare resin compositions of the Examples and Comparative Examples.

(Vinyl Chloride Resin)

Polyvinyl chloride: TK2000E (weight-average degree of polymerization: 2000); manufactured by Shin-Etsu Chemical Co., Ltd.

Polyvinyl chloride: TK2500PE (weight-average degree of polymerization: 3000); manufactured by Shin-Etsu Chemical Co., Ltd.

(Plasticizer)

Trimellitic acid plasticizer: ADK CIZER (registered trademark) C-880 (trimellitic acid-containing straight-chain alkyl ester); manufactured by Adeka Corporation

Pyromellitic acid plasticizer: ADK CIZER (registered trademark) UL-80 (pyromellitic acid 2-ethylhexyl ester); manufactured by Adeka Corporation

(Filler)

Flat filler 1: Hydritc RS (kaolin clay), average diameter: 0.8 μm (see FIG. 2); manufactured by Imerys

Flat filler 2: Hydrite 121-S(kaolin clay), average diameter: 1.5 μm (see FIG. 3); manufactured by Imerys

Substantially-spherical filler: Escalon #1500 (heavy calcium carbonate), average diameter: 2.5 μm; manufactured by Sankyo Seifun Co., Ltd.

(Stabilizer)

Ca/Zn-based stabilizer for polyvinyl chloride: ADK STAB (registered trademark) RUP-110; manufactured by Adeka Corporation

(Processing Auxiliary Agent)

Acrylic processing auxiliary agent: METABLEN (registered trademark) P-551; manufactured by Mitsubishi Rayon Co., Ltd.

Next, a copper core having a cross-sectional area of 1.8 mm² was prepared as a metal conductor. The resin compositions prepared in the Examples and Comparative Examples were each extruded at approximately 210° C. to cover the metal conductor with an extrusion covering apparatus for manufacturing electric wires, so as to produce test wire samples in the Examples and Comparative Examples. In each example, the resin composition extruded was adjusted such that the insulating coating had a thickness of 0.35 mm.

TABLE 1

| | Example 1 | Example 2 | Example 3 | Example 4 | Example 5 | Example 6 | Example 7 |
|---|---|---|---|---|---|---|---|
| Vinyl Chloride Resin | 100 | 100 | 100 | 100 | 100 | 100 | 100 |
| (TK2000E) (Parts by mass) | | | | | | | |
| Vinyl Chloride Resin | — | — | — | — | — | — | — |
| (TK2500PE) (Parts by mass) | | | | | | | |
| Plasticizer (Trimellitic Acid) | 40 | 40 | 40 | 40 | 40 | 30 | 30 |
| (Parts by mass) | | | | | | | |
| Plasticizer (Pyromellitic Acid) | — | — | — | — | — | — | — |
| (Parts by mass) | | | | | | | |
| Flat Filler 1 (Parts by mass) | 1 | 3 | 5 | 10 | 15 | 1 | 10 |
| Flat Filler 2 (Parts by mass) | — | — | — | — | — | — | — |
| Stabilizer (Parts by mass) | 5 | 5 | 5 | 5 | 5 | 5 | 5 |
| Processing Auxiliary Agent | 1 | 1 | 1 | 1 | 1 | 1 | 1 |
| (Parts by mass) | | | | | | | |
| High-Temperature Abrasion | ∘ | ∘ | ∘ | ∘ | ∘ | ∘ | ∘ |
| Resistance | | | | | | | |
| Low-Temperature Properties | ∘ | ∘ | ∘ | ∘ | ∘ | ∘ | ∘ |

TABLE 2

| | Example 8 | Example 9 | Example 10 | Example 11 | Example 12 | Example 13 | Example 14 |
|---|---|---|---|---|---|---|---|
| Vinyl Chloride Resin | 100 | 100 | 100 | 100 | — | — | — |
| (TK2000E) (Parts by mass) | | | | | | | |
| Vinyl Chloride Resin | — | — | — | — | 100 | 100 | 100 |
| (TK2500PE) (Parts by mass) | | | | | | | |
| Plasticizer (Trimellitic Acid) | 30 | 20 | 20 | 20 | 40 | 40 | 40 |
| (Parts by mass) | | | | | | | |
| Plasticizer (Pyromellitic Acid) | — | — | — | — | — | — | — |
| (Parts by mass) | | | | | | | |
| Flat Filler 1 (Parts by mass) | 15 | 1 | 5 | 15 | 1 | 5 | 15 |
| Flat Filler 2 (Parts by mass) | — | — | — | — | — | — | — |
| Stabilizer (Parts by mass) | 5 | 5 | 5 | 5 | 5 | 5 | 5 |
| Processing Auxiliary Agent | 1 | 1 | 1 | 1 | 1 | 1 | 1 |
| (Parts by mass) | | | | | | | |
| High-Temperature Abrasion | ∘ | ∘ | ∘ | ∘ | ∘ | ∘ | ∘ |
| Resistance | | | | | | | |
| Low-Temperature Properties | ∘ | ∘ | ∘ | ∘ | ∘ | ∘ | ∘ |

TABLE 3

| | Example 15 | Example 16 | Example 17 | Example 18 | Example 19 | Example 20 | Example 21 |
|---|---|---|---|---|---|---|---|
| Vinyl Chloride Resin | — | — | — | — | — | 100 | 100 |
| (TK2000E) (Parts by mass) | | | | | | | |
| Vinyl Chloride Resin | 100 | 100 | 100 | 100 | 100 | — | — |
| (TK2500PE) (Parts by mass) | | | | | | | |
| Plasticizer (Trimellitic Acid) | 40 | 40 | 40 | 20 | 20 | — | — |
| (Parts by mass) | | | | | | | |
| Plasticizer (Pyromellitic Acid) | — | — | — | — | — | 20 | 40 |
| (Parts by mass) | | | | | | | |
| Flat Filler 1 (Parts by mass) | — | — | — | 1 | 15 | 1 | 15 |
| Flat Filler 2 (Parts by mass) | 1 | 5 | 15 | — | — | — | — |
| Stabilizer (Parts by mass) | 5 | 5 | 5 | 5 | 5 | 5 | 5 |
| Processing Auxiliary Agent | 1 | 1 | 1 | 1.5 | 1.5 | 1 | 1 |
| (Parts by mass) | | | | | | | |
| High-Temperature Abrasion | ∘ | ∘ | ∘ | ∘ | ∘ | ∘ | ∘ |
| Resistance | | | | | | | |
| Low-Temperature Properties | ∘ | ∘ | ∘ | ∘ | ∘ | ∘ | ∘ |

TABLE 4

| | Comparative | Comparative | Comparative |
|---|---|---|---|
| | Example 1 | Example 2 | Example 3 |
| Vinyl Chloride Resin | 100 | 100 | — |
| (TK2000E) (Parts by mass) | | | |
| Vinyl Chloride Resin | — | — | 100 |
| (TK2500PE) (Parts by mass) | | | |
| Plasticizer (Trimellitic Acid) | 40 | 50 | 50 |
| (Parts by mass) | | | |
| Substantially-Spherical Filler | 5 | 30 | 10 |
| (Parts by mass) | | | |
| Stabilizer (Parts by mass) | 5 | 5 | 5 |
| Processing Auxiliary Agent | 1 | 1 | 1.5 |
| (Parts by mass) | | | |
| High-Temperature Abrasion | x | x | x |
| Resistance | | | |
| Low-Temperature Properties | ∘ | x | ∘ |

### Evaluation

The test wire samples obtained in the Examples and Comparative Examples were evaluated with regard to high-temperature abrasion resistance and low-temperature properties by the following methods. Tables 1 to 4 show the evaluation results thus obtained.

(High-Temperature Abrasion Resistance)

An abrasion test was performed on the test wire samples in the Examples and Comparative Examples by use of an abrading wire with a diameter of 0.45±0.01 mm as an abrading element in accordance with a scrape abrasion test described in ISO 6722:2006. The test was conducted in which the abrading element was moved repeatedly along the insulating coating while a load of 5±0.05 N was applied to each test wire sample under an atmosphere of 100±1° C. The evaluation was performed to determine whether there was an electrical connection between the metal conductor and the abrading wire, wherein a test wire sample that did not show an electrical connection after the number of abrasion cycles reached and exceeded 5 times was denoted by “∘”, and a test wire sample that showed an electrical connection before the number of abrasion cycles reached 5 times was denoted by “x”.

(Low-Temperature Properties)

First, the test wire samples in the Examples and Comparative Examples were cooled under the conditions of −40° C. in the air for 4 hours or more. Next, the cooled test wire samples were each wound spirally around a metal mandrel having the same diameter as each sample. Thereafter, a test voltage at 1 kV was applied for one minute between the metal mandrel and the metal conductor of each wound sample. The respective test wire samples were evaluated, wherein a test wire sample that did not cause dielectric breakdown was denoted by “∘”, and a test wire sample that resulted in dielectric breakdown was denoted by “x”.

It was revealed, as shown in Table 1, that the test wire samples in Examples 1 to 21 had high abrasion resistance at high temperature, so as to be used suitably for electric wires for vehicles. The test wire samples of these examples also exhibited high durability at low temperature.

On the other hand, the test wire samples in the Comparative Examples using the substantially-spherical filler resulted in insufficient abrasion resistance at high temperature. Even when the added amount of the substantially-spherical filler increased in Comparative Example 2, the abrasion resistance was not improved, but the durability at low temperature decreased.

While the present invention has been described above by reference to the respective examples, the present invention is not intended to be limited to the descriptions thereof, and various modifications will be apparent to those skilled in the art without departing from the scope of the present invention.

What is claimed is:

1. An electric wire for a vehicle comprising:
an insulating coating including a vinyl chloride resin, a plasticizer, and filler containing an inorganic compound having a flat shape; and
a conductor covered with the insulating coating,
wherein a number of abrasion cycles is five or greater when a scrape abrasion test is performed in accordance with ISO 6722:2006 on the electric wire having a total wire diameter in a range of 1.4 mm to 2.8 mm including a thickness of the insulating coating in a range of 0.24 mm to 0.4 mm, in a state where an abrading wire having a diameter of 0.45±0.01 mm is used for abrading and a load of 5±0.05 N is applied to the electric wire under an atmosphere of 100±1° C.

2. The electric wire for a vehicle according to claim 1, wherein the insulating coating contains the plasticizer in a range of 20 to 40 parts by mass per 100 parts by mass of the vinyl chloride resin, and contains the filler in a range of 1 to 15 parts by mass per 100 parts by mass of the vinyl chloride resin.

3. The electric wire for a vehicle according to claim 1, wherein a weight-average degree of polymerization of the vinyl chloride resin is in a range of 2000 to 3000, and the plasticizer is at least one of a trimellitic acid plasticizer and a pyromellitic acid plasticizer.

4. A wire harness comprising the electric wire for a vehicle according to claim 1.
